(19) United States
(12) Patent Application Publication
(10) Pub. No.: US 2024/0275692 A1
(43) Pub. Date: Aug. 15, 2024

(54) PROVIDE GRAPHICAL REPRESENTATION OF DATACENTER RACK

(71) Applicant: RAKUTEN SYMPHONY INDIA PRIVATE LIMITED, Indore,MP (IN)

(72) Inventors: Rauf QURESHI, Indore (IN); Rajat MEHRA, Indore (IN); Yamini JAIN, Indore (IN); Rounak LAHOTI, Indore (IN)

(73) Assignee: Rakuten Symphony India Private Limited, Indore, MP (IN)

(21) Appl. No.: 18/021,407

(22) PCT Filed: Jan. 19, 2023
(86) PCT No.: PCT/US2023/011123

§ 371 Date: Feb. 15, 2023

(30) Foreign Application Priority Data
Nov. 30, 2022 (IN) 20221068959

(51) Int. Cl. H04L 41/22; H04L 41/12

(52) U.S. Cl. CPC H04L 41/22; H04L 41/12

(57) ABSTRACT

Embodiments herein disclose a method and electronic device for providing a graphical representation of a datacenter rack. The method further includes determining, by the electronic device, whether at least one device is available in at least one slot of a plurality of slots of a rack of a datacenter. The method further includes determining a size of the at least one device when the at least one device is available in the at least one slot of the plurality of slots and determining a number of slots occupied by the at least one device based on the size of the at least one device. The method further includes generating a graphical representation of the rack of the datacenter based on the number of slots occupied by the at least one device. The method further includes displaying the graphical representation of the rack of the datacenter.

### CROSS-REFERENCE TO RELATED APPLICATION

This application is based on and claims priority to Indian Provisional Patent Application No. 202221068989 filed on Nov. 30, 2022, the disclosure of which is incorporated by reference herein in its entirety.

### FIELD OF INVENTION

The embodiments herein relate to an electronic device, and more particularly relate to a method and an electronic device for providing a graphical representation of a datacenter rack.

### BACKGROUND OF THE INVENTION

Generally, a datacenter is a dedicated space within a building to house computer systems and the datacenter has multiple racks to provide physical support to the computer systems. The racks of the datacenter are divided into multiple slots to hold computer systems such as servers, devices, and other components. A size of the multiple slots of the racks of the datacenter are different to hold the servers, the devices, and the other components of different sizes. A graphical representation of the racks of the datacenter is generated for managing and tracking the servers, the devices, and the other components. The slots in the graphical representation of the racks of the datacenter are of fixed size and the size of the slots in the graphical representation is not synchronized with the size of the multiple slots of the rack of the datacenter. Since the graphical representation is not synchronized with the size of the multiple slots, a user is not able to identify and track similar or dissimilar items like the servers, the devices, and the other components.

In the conventional method, the graphical representation of the slots of the data rack are of fixed size and need to be manually resized. For example, the user needs to estimate the slot size of the data rack and manually change the size of the slots in the graphical representation, which is a time-consuming task and often requires a lot of manual effort, especially in the case of a massive number of racks in the datacenter.

Hence, there is a high demand for generating the graphical representation of the data rack with variable slot sizes according to the multiple slot size of the rack.

### OBJECT OF INVENTION

The principal object of the embodiments herein is to provide a method and an electronic device for providing a graphical representation of a rack of a datacenter rack to monitor and track one or more devices in the rack of the datacenter.

Another object of the embodiments herein is to determine a size of the one or more devices while generating the graphical representation. Thus the size of the racks in graphical representation is not fixed and the size is dynamic based on the size of the one or more devices.

Another object of the embodiments herein is to generate a common representation by merging the one or more slots and a separate representation that horizontally splits the one or more slot. Therefore the proposed embodiment changes the slot sizes automatically which saves time and manual effort.

### SUMMARY

Accordingly, the embodiments herein disclose an electronic device for providing a graphical representation of a datacenter rack, the electronic device includes a memory, and a processor, communicatively coupled with the memory, configured to determine whether at least one device is available in at least one slot of a plurality of slots of a rack of a datacenter. The processor is further configured to determine a size of the at least one device when the at least one device is available in the at least one slot of the plurality of slots and determine a number of slots occupied by the at least one device based on the size of the at least one device. The processor is further configured to generate a graphical representation of the rack of the datacenter based on the number of slots occupied by the at least one device, wherein the graphical representation comprises at least one of a common representation of a set of slots from the plurality of slots occupied by the at least one device, a separate representation of a single slot from the plurality of slots occupied by the at least one device, and a single representation of at least one empty slot from the plurality of slots. The processor is further configured to display the graphical representation of the rack of the datacenter.

Accordingly, the embodiments herein disclose a method for providing graphical representation of the datacenter rack by the electronic device. The method further includes determining, by the electronic device, whether at least one device is available in at least one slot of the plurality of slots of the rack of the datacenter. The method further includes determining, by the electronic device, the size of the at least one device when the at least one device is available in the at least one slot of the plurality of slots and determining, by the electronic device, the number of slots occupied by the at least one device based on the size of the at least one device. The method further includes generating, by the electronic device, the graphical representation of the rack of the datacenter based on the number of slots occupied by the at least one device, wherein the graphical representation comprises at least one of the common representations of the set of slots from the plurality of slots occupied by the at least one device, the separate representation of the single slot from the plurality of slots occupied by the at least one device, and the single representation of at least one empty slot from the plurality of slots. The method further includes displaying, by the electronic device, the graphical representation of the rack of the datacenter.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram of an electronic device for providing a graphical representation of a datacenter rack, according to the embodiments as disclosed herein:

FIG. 2 is a flow diagram illustrating a method for providing the graphical representation of a datacenter rack, according to the embodiments as disclosed herein;

FIG. 3A is a schematic diagram illustrating the datacenter rack, according to the embodiments as disclosed herein;

FIG. 3B is a schematic diagram illustrating the graphical representation of the datacenter rack, according to the embodiments as disclosed herein; and

FIG. 4 is a flow chart illustrating a whole process involved in providing the graphical representation of a datacenter rack, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be constructed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein disclose an electronic device for providing graphical representation of a datacenter rack, the electronic device includes a memory, a processor, communicatively coupled with the memory, configured to determine whether at least one device is available in at least one slot of a plurality of slots of a rack of a datacenter. The processor is further configured to determine a size of the at least one device when the at least one device is available in the at least one slot of the plurality of slots and determine a number of slots occupied by the at least one device based on the size of the at least one device. The processor is further configured to generate a graphical representation of the rack of the datacenter based on the number of slots occupied by the at least one device, wherein the graphical representation comprises at least one of a common representation of a set of slots from the plurality of slots occupied by the at least one device, a separate representation of a single slot from the plurality of slots occupied by the at least one device, and a single representation of at least one empty slot from the plurality of slots. The processor is further configured to display the graphical representation of the rack of the datacenter.

Accordingly, the embodiments herein disclose a method for providing graphical representation of the datacenter rack by the electronic device. The method further includes determining, by the electronic device, whether at least one device is available in at least one slot of the plurality of slots of the rack of the datacenter. The method further includes determining, by the electronic device, the size of the at least one device when the at least one device is available in the at least one slot of the plurality of slots and determining, by the electronic device, the number of slots occupied by the at least one device based on the size of the at least one device. The method further includes generating, by the electronic device, the graphical representation of the rack of the datacenter based on the number of slots occupied by the at least one device, wherein the graphical representation comprises at least one of the common representation of the set of slots from the plurality of slots occupied by the at least one device, the separate representation of the single slot from the plurality of slots occupied by the at least one device, and the single representation of at least one empty slot from the plurality of slots. The method further includes displaying, by the electronic device, the graphical representation of the rack of the datacenter.

In existing systems, the slots in the graphical representation of the racks of the datacenter are fixed size and the size of the slots in the graphical representation is not synchronized with the size of the multiple slots of the rack of the datacenter. Therefore as the graphical representation is not synchronized with the rack of the datacenter, users cannot identify and track similar or dissimilar items like servers, devices, and other components using the graphical representation. Unlike the existing systems, in the proposed system and method the graphical representation is synchronized with the rack of the datacenter.

In existing systems, the graphical representation of the slots of the data rack are in fixed size and need to be manually resized. Unlike existing systems, the proposed system and method the size of the racks in graphical representation are not fixed and the size is dynamic based on the size of the one or more devices.

Unlike existing systems, the proposed system and method can generate the common representation by merging the one or more slots and the separate representation that horizontally splits the one or more slot which saves time and manual efforts in changing the slot sizes in the graphical representation.

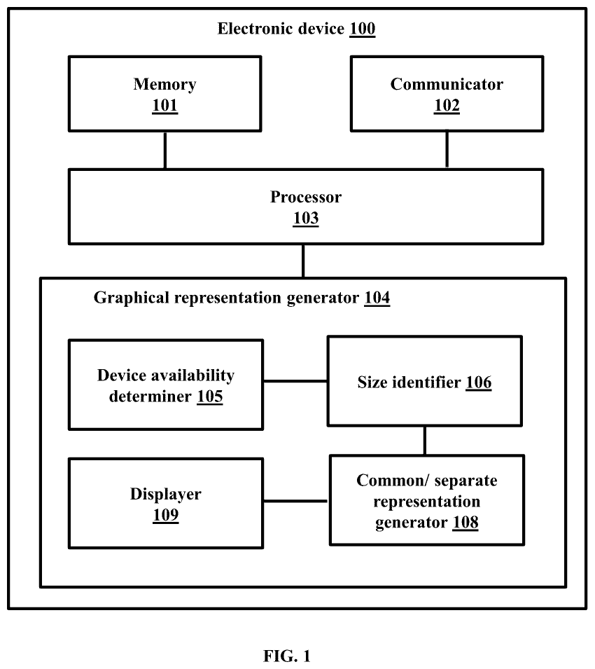

Referring now to the drawings, and more particularly to FIG. 1 through FIG. 5, there are shown preferred embodiments.

FIG. 1 is a block diagram of an electronic device (100) for providing a graphical representation of a datacenter rack, according to the embodiments as disclosed herein.

Referring to FIG. 1, examples of the electronic device (100) include but are not limited to a laptop, a palmtop, a desktop, a mobile phone, a smartphone, Personal Digital Assistant (PDA), a tablet, a wearable device, an Internet of Things (IOT) device, a virtual reality device, a foldable device, a flexible device, an immersive system, etc.

In an embodiment, the electronic device (100) includes a memory (101), a processor (103) and a communicator (102) and graphical representation generator (104).

The memory (101) stores instructions to be executed by the processor (103) for providing graphical representation of a datacenter rack. The memory (101) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (101) may, in some examples, be considered a non-transitory storage medium. The term “non-transitory” may indicate that the storage medium is not embodied in a carrier wave or a propagated signal. However, the term “non-transitory” should not be interpreted that the memory (101) is non-movable. In some examples, the memory (101) can be configured to store larger amounts of information than its storage space. In certain examples, a non-transitory storage medium may store data that can, over time, change (e.g., in Random Access Memory (RAM) or cache). The memory (101) can be an internal storage unit or it can be an external storage unit of the electronic device (100), a cloud storage, or any other type of external storage.

The processor (103) is configured to execute instructions stored in the memory (101). The processor (103) may be a general-purpose processor (103), such as a Central Processing Unit (CPU), an Application Processor (AP), or the like, a graphics-only processing unit such as a Graphics Processing Unit (GPU), a Visual Processing Unit (VPU) and the like. The processor (103) may include multiple cores to execute the instructions.

The communicator (102) is configured for communicating internally between hardware components in the electronic device (100). Further, the communicator (102) is configured to facilitate the communication between the electronic device (100) and other devices via one or more networks (e.g. Radio technology). The communicator (102) includes an electronic circuit specific to a standard that enables wired or wireless communication.

The processor (103) is coupled with graphical representation generator (104) and the graphical representation generator (104) is implemented by processing circuitry such as logic gates, integrated circuits, microprocessors, microcontrollers, memory (101) circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The graphical representation generator (104) includes a device availability determiner (105), a size identifier (106), a common/separate representation generator (108) and a displayer (109). The device availability determiner (105) determines whether at least one device is available in at least one slot of a plurality of slots of a rack of a datacenter. The size identifier (106) determines a size of the at least one device when the at least one device is available in the at least one slot of the plurality of slots and determines a number of slots occupied by the at least one device based on the size of the at least one device. The common or separate representation generator (108) generates the graphical representation of the rack of the datacenter based on the number of slots occupied by the at least one device. The graphical representation includes at least one of a common representations of a set of slots from the plurality of slots occupied by the at least one device, where the separate representation of a single slot from the plurality of slots occupied by the at least one device, and a single representation of at least one empty slot from the plurality of slots. The displayer (109) displays the graphical representation of the rack of the datacenter.

The processor (103) is configured to determine whether the size of the at least one device presents a tray mode or a normal mode, wherein the tray mode indicates at least one of multiple slots of the plurality of slots are occupied by multiple devices of the plurality of devices, the single slot of the plurality of slots are occupied by multiple devices of the plurality of devices, and wherein the normal mode indicates a single slot of the plurality of slots is occupied by a single device of the plurality of devices, and multiple slots of the plurality of slots are occupied by a single device of the plurality of devices.

Further, the processor (103) is configured to generate the common representation of the multiple slots by merging the multiple slots occupied by the multiple devices, and horizontally splitting the common representation based on the multiple devices when the tray mode indicates the multiple slots of the plurality of slots are occupied by the multiple devices of the plurality of devices. Further, the processor (103) is configured to generate the separate representation by horizontally splitting the single slot based on the multiple devices available in the single slot when the tray mode indicates the single slot of the plurality of slots is occupied by multiple devices of the plurality of devices. Further, the processor (103) is configured to generate the common representation of the multiple slots by merging the multiple slots occupied by the single device, when the normal mode indicates the multiple slots of the plurality of slots are occupied by the single device of the plurality of devices. Further, the processor (103) is configured to generate the separate representation of the single slot occupied by the single device when the normal mode indicates the single slot of the plurality of slots is occupied by the single device of the plurality of devices.

The processor (103) is configured to identify a start slot number and an end slot number (e.g. 1 and 3) of the at least one device and determine whether the start slot number is equal to the end slot number of the at least one device. Further, the processor (103) is configured to generate the separate representation of the single slot occupied by the single device when the start slot number is equal to the end slot number of the at least one device. Further, the processor (103) is configured to generate the separate representation by horizontally splitting the single slot based on the multiple devices available in the single slot when the start slot number is equal to the end slot number of the at least one device.

The processor (103) is configured to determine whether the start slot number is not equal to the end slot number of the at least one device and determine whether the start slot number of the at least one device is equal to a start slot number of an index of the rack. Further, the processor (103) is configured to generate the common representation with a top boundary of the multiple slots occupied by the at least one device when the start slot number of the at least one device is equal to the start slot number of the index of the rack.

The processor (103) is configured to determine whether the start slot number of the at least one device is equal to an end slot number of the index of the rack. Further, the processor (103) is configured to generate the common representation with a bottom boundary of the multiple slots occupied by the at least one device when the start slot number of the at least one device is equal to the end slot number of the index of the rack. Further, the processor (103) is configured to generate the common representation with no boundary of the multiple slots occupied by the at least one devices when the start slot number of the at least one device is not equal to the end slot number of the index of the rack.

The processor (103) is configured to classify the at least one device in the rack of the datacenter and display the graphical representation with color coding for the at least one device of the rack of the datacenter based on the classification of the at least one device.

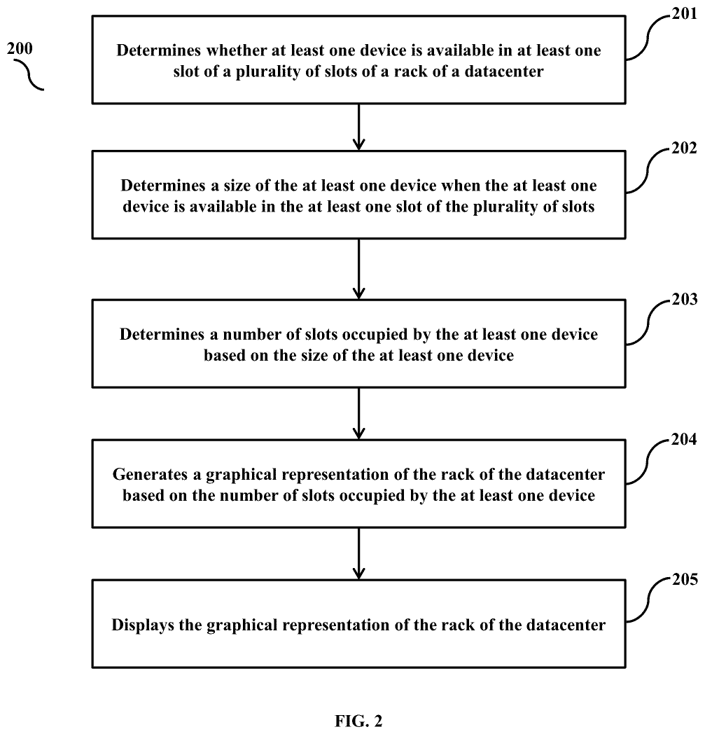

FIG. 2 is a flow diagram illustrating a method for providing graphical representation of a datacenter rack, according to the embodiments as disclosed herein.

The step 201 to step 205 of the flow diagram (200) are performed by the electronic device (100).

At step 201, the electronic device (100) determines whether at least one device is available in at least one slot of a plurality of slots of a rack of a datacenter.

At step 202, the electronic device (100) determines the size of the at least one device when the at least one device is available in the at least one slot of the plurality of slots.

At step 203, the electronic device (100) determines a number of slots occupied by the at least one device based on the size of the at least one device.

At step 204, the electronic device (100) generates a graphical representation of the rack of the datacenter based on the number of slots occupied by the at least one device.

At step 205, the electronic device (100) displays the graphical representation of the rack of the datacenter.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

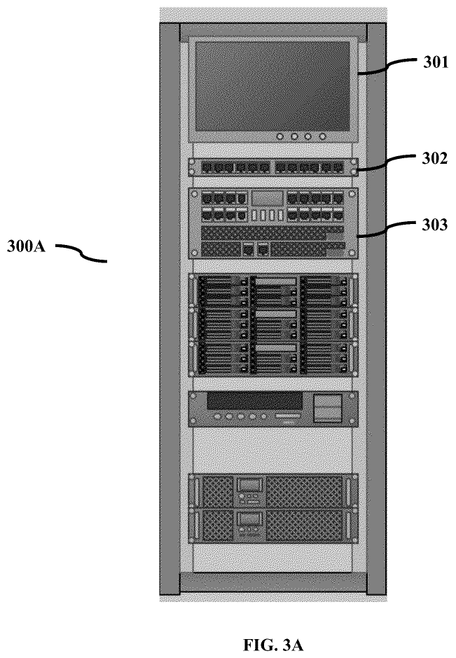

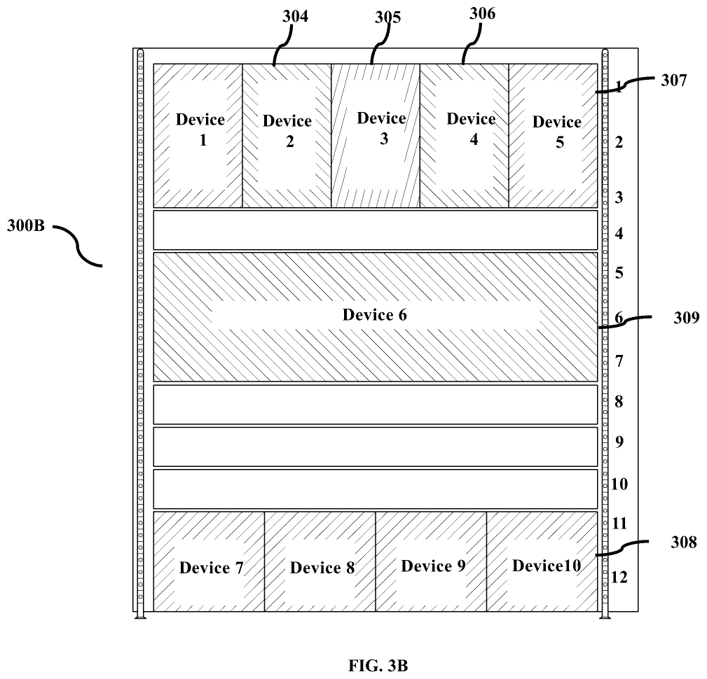

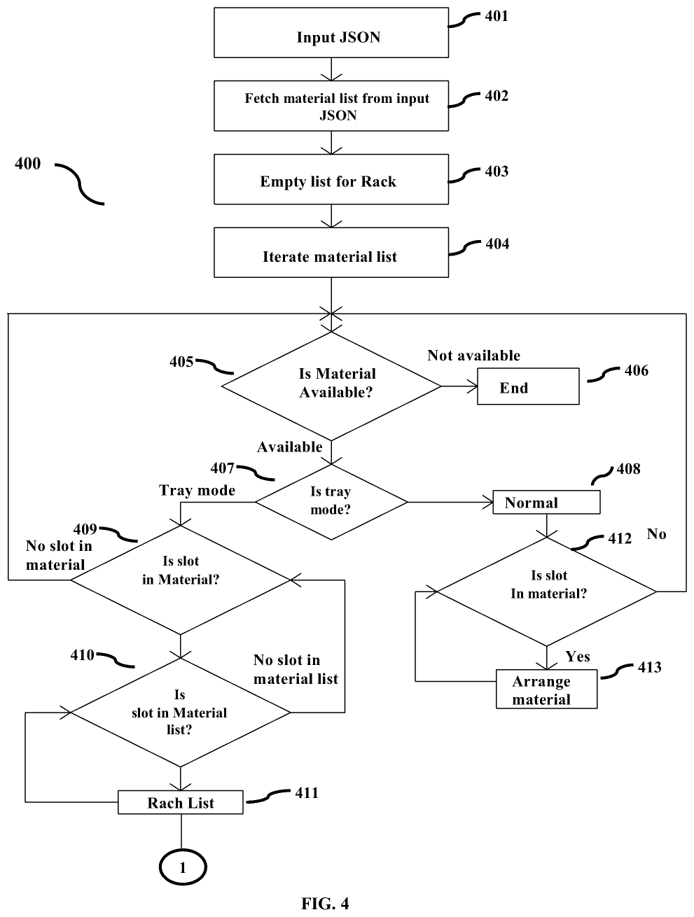

FIG. 3A is a schematic diagram illustrating the datacenter rack (300A), according to the embodiments as disclosed herein.

The datacenter rack (300A) is an important tool for datacenters, the datacenter rack holds equipments such as routers, servers, audio or video components, hubs, and switches. The datacenter racks have multiple slots in different sizes (301-303) to hold different device of different sizes.

FIG. 3B is a schematic diagram illustrating the graphical representation of the datacenter rack (300B), according to the embodiments as disclosed herein.

The graphical representation of the datacenter rack (300B) comprises the plurality of slots (304-309) of various sizes of the devices (1-10). The size of the slot for the device 6 is bigger when compared with the size of slots for the devices (1-5). Therefore the proposed system displays the graphical representation of the datacenter rack (300B) with various sizes of slots automatically.

The processor (103) is configured to determine the size of the devices (1-10) when the at least one device is available in the at least one slot of the plurality of slots (304-309). The processor (103) is further configured to determine the number of slots occupied by the devices (1-10) based on the size of the at least one device. The processor (103) is further configured to generate a graphical representation of the rack of the datacenter based on the number of slots occupied by the at least one device, wherein the graphical representation comprises at least one of a common representation of a set of slots i.e. slot 309 from the plurality of slots occupied by the device 6, the separate representation of a single slots (304-306) occupied by the devices (1-5), and the single representation of the empty slot, as the slots 4 and 8-10 are without any devices.

The proposed method can similarly accommodate the single device in the single slot and multiple device in the single slot.

In the proposed method, when a device requires four slots, the electronic device (100) merge four slots in the graphical representation and display as a single slot. In another embodiment, when four devices require to be displayed in four slots, the electronic device (100) will merge the four slots into a single merged slot and split the merged slot vertically to have four devices

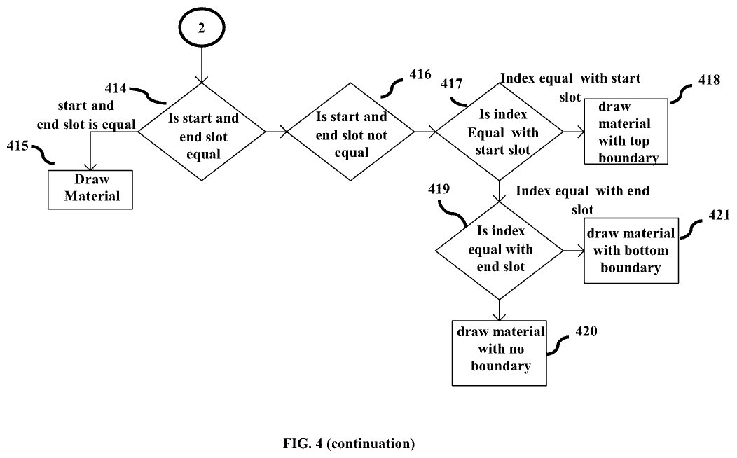

FIG. 4 is a flow chart (400) illustrating a whole process involved in providing the graphical representation of a datacenter rack, according to the embodiments as disclosed herein.

At 401, the electronic device (100) receives a JSON as an input for processing, the JSON is inputted by the user or extracted from a stored data and at 402, and the electronic device (100) fetches a device list of the rack of the datacenter from the inputted JSON. The device list has the list of devices in the rack of the datacenter along with the details of the devices such as size, location, the slot number of the rack and others.

At 403, the electronic device (100) creates an empty list for the rack represented graphically with slots of equal sizes, At 404, the electronic device (100) iterate the device one by one from the device list.

At 405, the electronic device (100) detects whether device is available in a particular slot of the rack of the datacenter, the electronic device (100) at 406, ends the process when device is not available in a particular slot of the rack of the datacenter.

At 407, the electronic device (100) determines whether the type of the device which is iterated is tray mode. In the tray mode multiple devices are graphically represented in the multiple slot or the single slot of the datacenter rack.

At 408, the electronic device (100) determines the device as normal mode when the type of the device which is iterated is not in tray mode.

At 412, the electronic device (100) determines whether slot details of the device are present or not, if the slot details in the device are not present, the electronic device (100) will begin to iterate with step 405.

At 414, the electronic device (100) graphically represents the device in the slot, when the slot details of device is present. The device which is the single device is graphically represented in the single slot or multiple slot.

At 409, the electronic device (100) determines whether slot details of device when the type of the device which is iterated is tray mode, if the slot details in device is not present, the electronic device (100) will begin to iterate with step 405.

At 410, the electronic device (100) determines whether the start slot number and end slot number are present in the device details. The electronic device (100) will perform step 410 when the start slot number and end slot number are not present in the device details.

At 411, the electronic device (100) stores the devices in a device item list when the start slot number and end slot number are present in the device details.

At 414, the electronic device (100) determines whether the start and end slot number of the devices in the list are equal.

At 415, the electronic device (100) graphically represent the one or more device having start and end slot number as equal in the slot of the graphical representation, and at 416, the electronic device (100) determines whether the start and end slot number of the devices in the list are not equal and draw the device.

At 417, the electronic device (100) checks whether the index is equal to the start slot number, wherein the index is prepared with the rack device list.

At 418, the electronic device (100) determines the top boundary when the index is equal with the start slot number and draws device with top boundary.

At 419, the electronic device (100) determines whether the index is equal with the end slot number when the index is not equal with the start slot number.

At 420, the electronic device (100) determines no boundary for the device when the index is not equal with the end slot number draw device with no boundary.

At 421, the electronic device (100) determines the bottom boundary for arranging the device when the index is equal with the end slot number and draw device with bottom boundary.

The proposed method and system have the following advantages:
1. The proposed system can display graphical representation of a datacenter rack in mobile device or in any user equipments.
2. The proposed method and system provides a unique solution of merging and splitting slots
3. The devices may have same or different rack slot size which is calculated dynamically and the slots are merge or split.
4. The graphical representation of a rack of a datacenter rack helps to monitor and track one or more devices in the rack of the datacenter.
5. The size of the racks in graphical representation are not fixed and the size are dynamic based on the size of the one or more devices.
6. The proposed system can change the slot sizes automatically which saves time and manual efforts.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. An electronic device for providing graphical representation of a datacenter rack, comprising:
a memory; and
a processor, communicatively coupled with the memory, configured to:
determine whether at least one device is available in at least one slot of a plurality of slots of a rack of a datacenter;
determine a size of the at least one device when the at least one device is available in the at least one slot of the plurality of slots;
determine a number of slots occupied by the at least one device based on the size of the at least one device;
generate a graphical representation of the rack of the datacenter based on the number of slots occupied by the at least one device, wherein the graphical representation comprises at least one of a common representation of a set of slots from the plurality of slots occupied by the at least one device, a separate representation of a single slot from the plurality of slots occupied by the at least one device, and a single representation of at least one empty slot from the plurality of slots; and
display the graphical representation of the rack of the datacenter.

2. The electronic device as claimed in claim 1, wherein generate the graphical representation of the rack of the datacenter based on the number of slots occupied by the at least one device comprises:
determine whether the size of the at least one device presents a tray mode or a normal mode, wherein the tray mode indicates at least one of multiple slots of the plurality of slots are occupied by multiple devices of the plurality of devices, the single slot of the plurality of slots are occupied by multiple devices of the plurality of devices, and wherein the normal mode indicates a single slot of the plurality of slots is occupied by a single device of the plurality of devices, and multiple slots of the plurality of slots are occupied by a single device of the plurality of devices; and
perform one of:
generate the common representation of the multiple slots by merging the multiple slots occupied by the multiple devices, and horizontally splitting the common representation based on the multiple devices when the tray mode indicates the multiple slots of the plurality of slots are occupied by the multiple devices of the plurality of devices,
generate the separate representation by horizontally splitting the single slot based on the multiple devices available in the single slot when the tray mode indicates the single slot of the plurality of slots are occupied by multiple devices of the plurality of devices,
generate the common representation of the multiple slots by merging the multiple slots occupied by the single device, when the normal mode indicates the multiple slots of the plurality of slots are occupied by the single device of the plurality of devices, and
generate the separate representation of the single slot occupied by the single device when the normal mode indicates the single slot of the plurality of slots is occupied by the single device of the plurality of devices.

3. The electronic device as claimed in claim 1, wherein generate the separate representation comprises:
identify a start slot number and an end slot number of the at least one device;
determine whether the start slot number is equal to the end slot number of the at least one device; and
perform one of:
generate the separate representation of the single slot occupied by the single device when the start slot number is equal to the end slot number of the at least one device; or
generate the separate representation by horizontally splitting the single slot based on the multiple devices available in the single slot when the start slot number is equal to the end slot number of the at least one device.

4. The electronic device as claimed in claim 1, wherein generate the common representation comprises:
determine whether the start slot number is not equal to the end slot number of the at least one device;
determine whether the start slot number of the at least one device is equal to an start slot number of an index of the rack; and
generate the common representation with a top boundary of the multiple slots occupied by the at least one devices when the start slot number of the at least one device is equal to the start slot number of the index of the rack;

5. The electronic device as claimed in claim 1, wherein generate the common representation comprises:
determine whether the start slot number of the at least one device is equal to an end slot number of the index of the rack; and
perform one of:
generate the common representation with a bottom boundary of the multiple slots occupied by the at least one devices when the start slot number of the at least one device is equal to the end slot number of the index of the rack: or
generate the common representation with no boundary of the multiple slots occupied by the at least one devices when the start slot number of the at least one device is not equal to the end slot number of the index of the rack

6. The electronic device as claimed in the claim 1, wherein display the graphical representation of the rack of the datacenter comprises:
classify the at least one device in the rack of the datacenter: and
display the graphical representation with color coding for the at least one device of the rack of the datacenter based on the classification of the at least one device.

7. A method for providing graphical representation of a datacenter rack by an electronic device, comprising:
determining, by the electronic device, whether at least one device is available in at least one slot of a plurality of slots of a rack of a datacenter:
determining, by the electronic device, a size of the at least one device when the at least one device is available in the at least one slot of the plurality of slots:
determining, by the electronic device, a number of slots occupied by the at least one device based on the size of the at least one device:
generating, by the electronic device, a graphical representation of the rack of the datacenter based on the number of slots occupied by the at least one device, wherein the graphical representation comprises at least one of a common representation of a set of slots from the plurality of slots occupied by the at least one device, a separate representation of a single slot from the plurality of slots occupied by the at least one device, and a single representation of at least one empty slot from the plurality of slots; and
displaying, by the electronic device, the graphical representation of the rack of the datacenter.

8. The method as claimed in claim 7, wherein generating, by the electronic device, the graphical representation of the rack of the datacenter based on the number of slots occupied by the at least one device comprises:
determining, by the electronic device, whether the size of the at least one device presents a tray mode or a normal mode, wherein the tray mode indicates at least one of multiple slots of the plurality of slots are occupied by multiple devices of the plurality of devices, the single slot of the plurality of slots are occupied by multiple devices of the plurality of devices, and wherein the normal mode indicates a single slot of the plurality of slots is occupied by a single device of the plurality of devices, and multiple slots of the plurality of slots are occupied by a single device of the plurality of devices; and
performing, by the electronic device, one of:
generating the common representation of the multiple slots by merging the multiple slots occupied by the multiple devices, and horizontally splitting the common representation based on the multiple devices when the tray mode indicates the multiple slots of the plurality of slots are occupied by the multiple devices of the plurality of devices,
generating the separate representation by horizontally splitting the single slot based on the multiple devices available in the single slot when the tray mode indicates the single slot of the plurality of slots are occupied by multiple devices of the plurality of devices,
generating the common representation of the multiple slots by merging the multiple slots occupied by the single device, when the normal mode indicates the multiple slots of the plurality of slots are occupied by the single device of the plurality of devices, and
generating the separate representation of the single slot occupied by the single device when the normal mode indicates the single slot of the plurality of slots is occupied by the single device of the plurality of devices.

9. The method as claimed in claim 7, wherein generating, by the electronic device, the separate representation comprises:
identifying, by the electronic device, a start slot number and an end slot number of the at least one device:
determining, by the electronic device, whether the start slot number is equal to the end slot number of the at least one device: and
performing, by the electronic device, one of:
generating the separate representation of the single slot occupied by the single device when the start slot number is equal to the end slot number of the at least one device; or
generating the separate representation by horizontally splitting the single slot based on the multiple devices available in the single slot when the start slot number is equal to the end slot number of the at least one device.

10. The method as claimed in claim 7, wherein generating, by the electronic device, the common representation comprises:
determining, by the electronic device, whether the start slot number is not equal to the end slot number of the at least one device;
determining, by the electronic device, whether the start slot number of the at least one device is equal to an start slot number of an index of the rack: and
generating, by the electronic device, the common representation with a top boundary of the multiple slots occupied by the at least one devices when the start slot number of the at least one device is equal to the start slot number of the index of the rack:

11. The method as claimed in claim 7, wherein generating, by the electronic device, the common representation comprises:
determining, by the electronic device, whether the start slot number of the at least one device is equal to an end slot number of the index of the rack; and
performing, by the electronic device, one of:
generating the common representation with a bottom boundary of the multiple slots occupied by the at least one devices when the start slot number of the at least one device is equal to the end slot number of the index of the rack: or
generating the common representation with no boundary of the multiple slots occupied by the at least one devices when the start slot number of the at least one device is not equal to the end slot number of the index of the rack

12. The method as claimed in the claim 7, wherein displaying, by the electronic device, the graphical representation of the rack of the datacenter comprises:
classifying, by the electronic device, the at least one device in the rack of the datacenter: and
displaying, by the electronic device, the graphical representation with color coding for the at least one device of the rack of the datacenter based on the classification of the at least one device.
